(19) United States
(12) Patent Application Publication
(10) Pub. No.: US 2001/0048747 A1
(43) Pub. Date: Dec. 6, 2001

(54) Method and device for implementing secured data transmission in a networked environment

(76) Inventor: Terry O'Brien, Mission, KS (US)

Correspondence Address: Richard R. Johnson, SHOOK, HARDY & BACON L.L.P., 1200 Main Street, Kansas City, MO, 64105-2118, US

(21) Appl. No.: 09/835,424

(22) Filed: Apr. 16, 2001

Related U.S. Application Data
(60) Provisional application No. 60/200,124, filed on Apr. 27, 2000.

(51) Int. Cl. H04L 9/00; G06F 12/14

(52) U.S. Cl. 380/277; 713/183; 707/9

(57) ABSTRACT

A method is provided for use in the secured transmission of information in a networked environment. Network communications are bi-directionally enabled and encrypted. The need or ability for any individual to access an account encryption Key is eliminated and only communication devices have access to an operational account Key that is used to encrypt or decrypt data passing through the device. A master Key is established and stored at a Recipient Device. Messages that are sent to the Recipient Device may optionally include an intermediate Key exclusive to that message. A method of integrating security hardware to protect the integrity of account data and Keys is also provided. Hardware or software tampering is also monitored. A method of sending the Key to a device in an encrypted form during registration is also provided. A method to perform all encryption and decryption without impeding the data communication rate is provided.

### CROSS-REFERENCE TO RELATED APPLICATIONS

This application claims the benefit of U.S. provisional application Ser. No. 60/200124 filed Apr. 27, 2000.

### FIELD OF THE INVENTION

In general, the present invention relates to computer networks, and in particular, to a method and device for communication and security of information in a networked environment.

### BACKGROUND OF THE INVENTION

In general, communication of data over phone lines, or other medium, is susceptible to being overheard by persons other than those for whom it is intended. The prolific use of various communication media for the exchange of sensitive and confidential information increases the vulnerability of individuals and organizations to the unscrupulous acts of others. The effect of having unauthorized access to information is further compounded by the fact that the owners of the “stolen” information are typically unaware of the theft and the information can typically be used in a countless variety of scams. Tracking down “stolen” information can be extremely difficult. The punishment for the offender and the recourse for the owner are not yet fully defined by the law as this is a new and difficult area to grasp. For example, it is not clear whether the owner of any particular data is the person with the data repository i.e. the person who collected the data, or whether it is the individual who is the actual subject of the collected data. It is also not clear what penalties exist or should exist for the “theft” of data.

At present, the best security against this kind of illegal activity is encryption. Encryption is a method of altering data by a succession of logical or mathematical operations such that the altered data that is sent over the network is rendered meaningless unless and until the necessary operations are performed to restore the data in its original form. The process of altering and restoring information is accomplished by means of what is generally referred to as a Key. The Key is a mathematical expression that will effectively enable and negate the operations performed to encrypt the data.

The complexity and attributes of the encryption method chosen depend on the application. In a situation where a Key has been repeatedly used, it is quite possible that an unauthorized individual may be able to decipher the Key and thus have access to all subsequent information. In this type of a situation, it is desirable to have the ability to use different Keys. However, a problem arises because the Key must be known both on the sending and receiving ends of the communication. In the case of users separated by a great distance, transfer of the Key must be communicated by some means other than a face-to-face meeting, in which case the unauthorized listeners can just as easily acquire the new Key if it is transmitted between the users. One solution to this problem has been to incorporate a code that factors in the date and message number into the Key. This will only marginally increase the complexity of the encryption but significantly reduce the chance of breaking the code.

A method that is frequently used is to send the Key and data in the same transmission. Assuming that there were no unauthorized listeners this method would suffice. However, since listeners are generally in tune with this methodology, the purpose is defeated. The other problem that is presented by this popular method is the assumption that the recipient is the intended recipient merely because the recipient has the correct password or piece of equipment, either of which could have been illegally obtained.

There will always be some amount of risk. There are, however, ways to make the situation more secure without introducing too much complexity. This is typically done by a re-examination of established methods in light of new technology and methodologies.

Accordingly, there exists a need for better encryption of information that is communicated over a network. Moreover, there is a need for such a method and system to create more dynamic and efficient security of data without compromising the rate of data transmission.

### SUMMARY OF THE INVENTION

Generally described, a method is provided for use in the secured transmission of information in a networked environment. In accordance with the method, communication between two components in a network is bi-directionally enabled and encrypted in both directions. The originating end of the communication, referred to as the “Sending” or “Transmitting Device”, and the receiving end, referred to as the “Recipient Device”, provide a user with the ability to send files or communicate in real time in a completely secure manner.

A method of preventing all human access to secure communications is also provided. The need or ability for any individual to access an account encryption Key is eliminated. Account Keys may be partially accessible, but only the device itself rather than the User has access to an operational account Key, which is needed to encrypt or decrypt data passing through the device.

A method of requiring a device or account owner to register his/her account with the recipient device before encryption can occur is also provided. According to the method, a master Key is established and stored at the Recipient Device. Messages that are sent to the Recipient Device may optionally include an intermediate Key exclusive to that message. Furthermore, registration of the communication device represents an agreement to comply with the Secure Protocols, Policies, Procedures and Penalties Program (SP5 Committee) rules regarding the regulation of encrypted communications and encryption equipment.

A method of integrating security hardware to protect the integrity of account data and Keys is also provided. This method further enables the registration and data routing process to be automated, thus preventing the need to expose any person to the encryption Keys. This aspect of the invention is implemented in a software program that monitors hardware or software tampering and takes appropriate measures to secure information that is resident on the device.

A method of sending the Key to a device in an encrypted form during registration is provided. In accordance with the method, account registration may occur at anytime of the day or night and occur automatically and unassisted within a very short time duration.

A method to perform all encryption and decryption at speeds that do not impede the potential data communication rate is provided. In accordance with this method, the Key is associated with a particular account rather than being a part of each coded transmission.

### BRIEF DESCRIPTION OF THE DRAWINGS

The present invention is described in detail below with references to the attached drawing figures, where in:

FIG. 1 is a block diagram illustrative a communication network suitable for use in implementing the present invention;

FIG. 2 is a block diagram illustrative of the preferred components of a terminal in accordance with the present invention;

FIG. 3 is a block diagram illustrating a preferred schematic to detect the physical disconnection of a device card from a PC board;

FIG. 4 is a flow diagram illustrating the communication and encryption between devices;

FIG. 5 is a flow diagram illustrating a preferred method to obtain a Key on each of the sending device and recipient device; and

FIG. 6 is a block diagram illustrating the sub-components of a Key.

### DETAILED DESCRIPTION OF THE INVENTION

The present invention provides a method and system for implementing an open-ended computing system having a plurality of networked terminals in a graphical user interface (GUI) environment for the secured transmission of information. The invention is operable with numerous general or special purpose computing systems. Examples of well known computing systems that may be suitable for use with the invention include, personal computers; server computers; note-book computers; hand-held or laptop devices; multiprocessor systems; networked personal computers; minicomputers; and mainframe computers. As would be readily understood by someone skilled in the relevant art, additional or alternative computing environments or computing components are within the scope of the present invention.

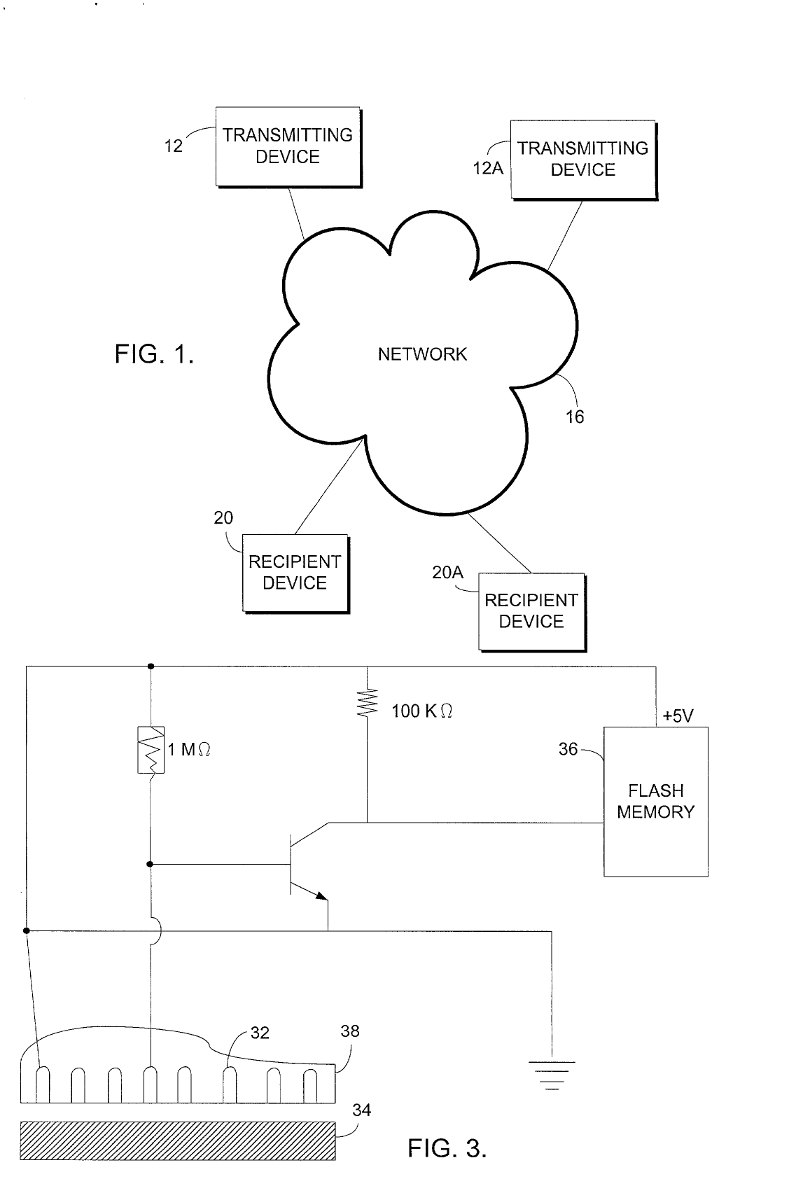

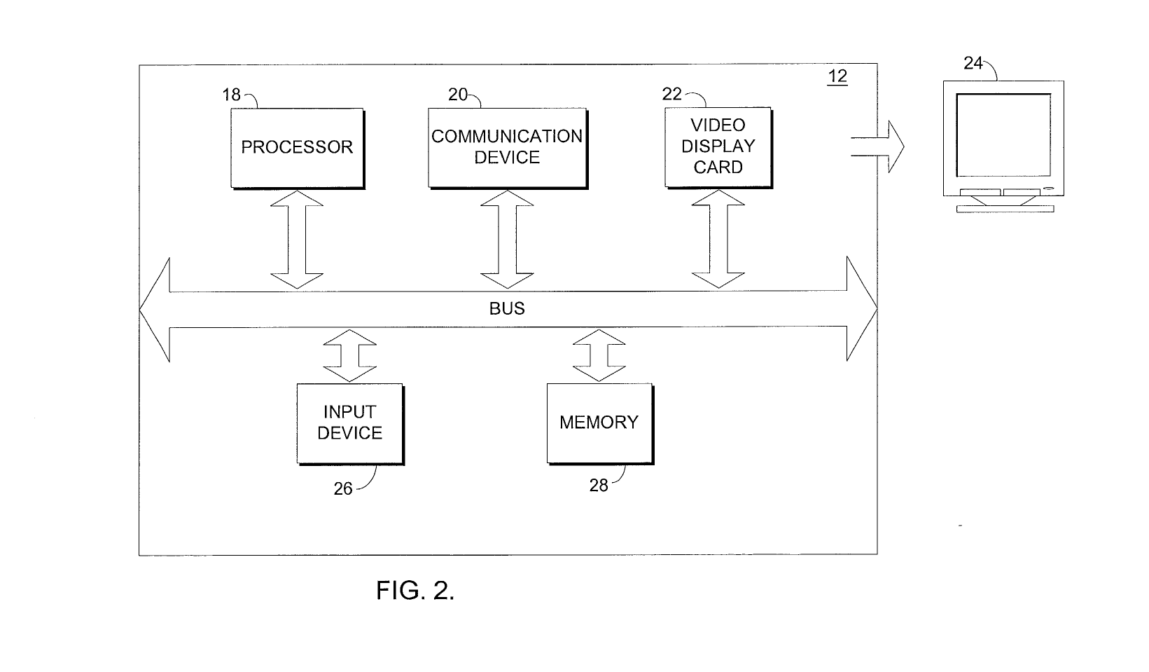

In order to utilize the methods discussed herein, there must be a minimum of two devices with the necessary physical connections to facilitate communication. FIG. 1 is a block diagram of the centralized network of the present invention, designated generally by the reference number 10. The originating end of the communication referred to as the “Transmitting Device” and the receiving end referred to as the “Recipient Device”, provide a user with the ability to exchange files or communicate in real time. The GUI network 10 includes one or more transmitting devices 12 in communication with one or more recipient devices 20 via a communication network 16. Preferably, the communication network 16 includes a Local Area Network (LAN), such as an Ethernet link, which provides each transmitting device 12 access to the recipient device 20. As would be readily understood, the communication network 16 may also encompass Wide Area Networks (WAN), Telephonic line or a combination of various network configurations. The devices referred to in this paragraph can also take several forms. However, there are some minimal component requirements as illustrated in FIG. 2.

FIG. 2 is a block diagram representative of an embodiment of the transmitting and receiving devices previously discussed in accordance with the present invention. The device 12 illustrated in FIG. 2 is representative of either type of device. The device 12 depicted in FIG. 2 can be implemented on a single silicon die. With reference to FIG. 2, each device 12 preferably includes a micro-controller having a minimal memory component 18; a communications device 20; such as a 10/100 Base T network interface; a video display driver 22; a terminal display 24; and one or more input devices 26 such as a mouse or a keyboard. Apart from the potential hardware configuration discussed so far, the methods of the present invention can also be utilized in a software configuration.

In an alternative embodiment, a device 12 may be a conventional personal computer (PC), which typically have the above-listed components as well as additional components for supporting an independent operating environment. In this alternative embodiment, the PC terminal would emulate the preferred device 12, by executing a special program and would also be able to function as a stand-alone PC. This alternative embodiment allows the network of the present invention, with some minor software modifications, to accommodate alternative or pre-existing computing systems in the general network 10 (FIG. 1). The security of the data in this invention is closely linked to the hardware. Therefore, it is necessary to provide a means for also protecting or at least detecting, and acting on a breach of physical hardware security. Such a means is depicted in FIG. 3.

FIG. 3 is an illustration of a type of recipient device 20 or transmitting device 12 as previously discussed with reference to FIG. 1 that plugs into the card slot 34 of a PC compatible computer along with a circuitry 30 for detecting disconnection. This device receives its power and ground, as well as all the data and address lines, needed for control and communication from the slot connection. Additionally, the metal faceplate of the recipient device has a connection for a 10/100 Base T type CAT 5 communication connector. This device will erase the Flash Memory 36 that holds all encryption information if the device is unplugged from the card cage without first entering the proper unlock code. The method used to trigger this erasure is primarily mechanical and operates on the premise that the circuitry on the PC board needs to “know” that the PC card device is being pulled out of the card cage regardless of whether the PC is on or off. This is accomplished by means of a circuitry 30 that requires the connection, between two PC board fingers 32 and ground, to have a resistance of less that 5 Ohms from one board finger 32 to the other. When a card is pulled out of the card cage, the resistance will go to greater than 100 K Ohms, which will cause the erasure of the flash memory. At least one of the fingers 32 is sized and positioned to prevent an individual from bypassing the circuitry 30 with jumper wires or any such physical tampering. As discussed earlier, one of the most effective security options is the utilization of software Keys for encryption at one end and decryption at the other end of the communication. The present invention provides a unique method for communicating and securing a Key.

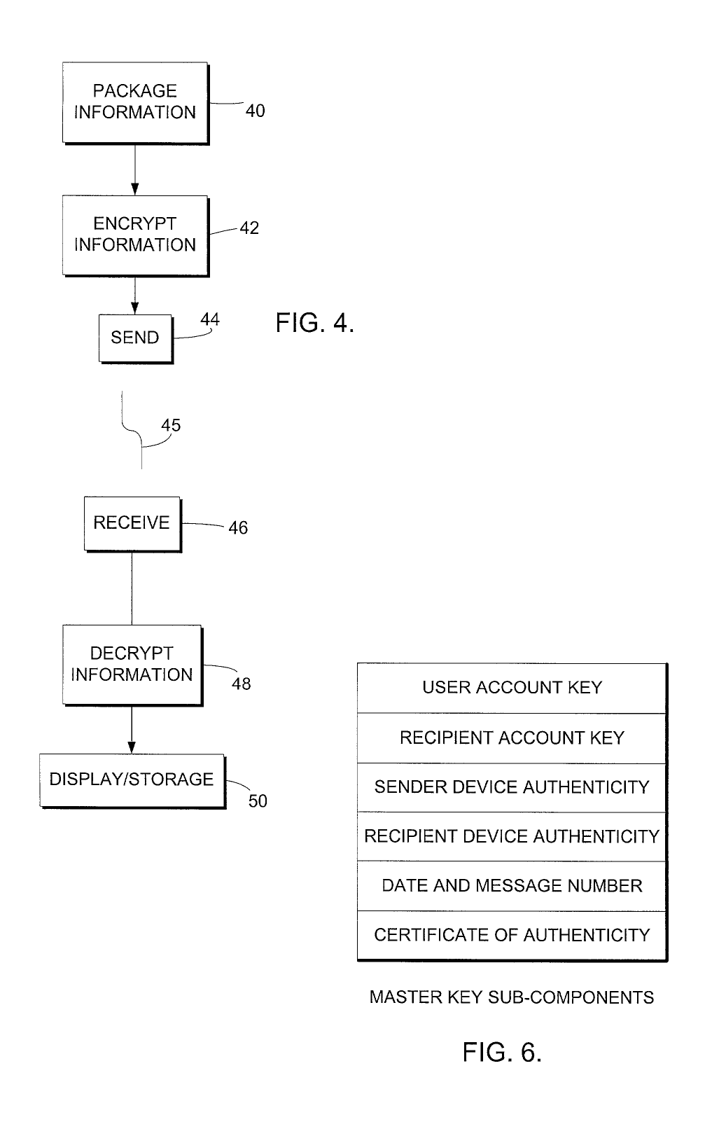

FIG. 4 is a flow diagram illustrating a method of facilitating the transfer and receipt of data between two or more devices without compromising the security of the communication. Accordingly, the system can be implemented by the use of an encryption method that utilizes a Key. Encryption entails the method of altering data by a succession of logical or mathematical operations prior to sending the information across the network or other communication medium. The first stage is the creation of data packets to which the encryption algorithm will be applied as shown in step 40. The actual process of encryption at step 42 follows this. Encryption renders the data meaningless until the necessary operations are performed to restore the data to its original form. The encrypted data is sent at step 44, over some communication medium 45 to a Recipient Device. In order to facilitate the decryption of the information on the recipient end, a Key, or in other words, the mathematical expression that will negate the operations performed to encrypt the data, must be communicated to the recipient device. This requirement is the focus of this invention. In one embodiment of this invention, which is more fully discussed later on in this document, the Key is generated on both ends of a communication based on a method of transmitting and exchanging a series of sub-Key components.

On the recipient side of this communication, the encrypted data is received at step 46, and then the data is restored to its original form by a process of decryption at step 48. Finally, at step 50, the data is stored or displayed according to the intention of the users.

As mentioned earlier, a critical function in the secured transmission of information over a network is the encryption and decryption of the data. The security of a system hinges on the ability to efficiently and securely communicate the Key between the devices. The inventive process of generating a Key on at least a pair of Transmitting and Recipient Devices will now be described with reference to FIG. 5.

As shown in FIG. 5, in step 502, the inventive encryption system accepts the entry of a user account number, which was originally generated or stored within the system. Depending on whether the device is a transmitter or recipient the subsequent steps and procedures will vary as indicated at step 504. The ultimate goal in either case is to generate a Master Account Key that is used in subsequent communications.

In the case of a transmitting device, a User Account Key (UAK) is created by the device at step 506, followed by an attempt to connect to one or more recipient devices at step 507 This attempt to connect with a recipient is initiated by sending out a User Account Number (UAN), step 508. The transmitting device then waits for a response in the form of a Recipient Account Key (RAK), which signals a successful connection to a recipient, and more importantly, recognition of the transmitting device by the Recipient Device. The Transmitting Device sends the UAK in step 512, and then an exclusive-or is performed on the UAK and RAK to obtain a Master Account Key (MAK) at step 514.

In the case of a Recipient Device, at step 516, nothing occurs until a UAN is received from a Transmitting Device. The receipt of a UAN triggers the recipient device to respond by sending a RAK in step 518, to the Transmitting Device. This in turn causes the Transmitting Device to send a UAK to the Recipient Device. The receipt of a UAK causes the Recipient Device to perform an exclusive or on the UAK and RAK to obtain a MAK, at step 522.

In both devices, the MAK is retained by the device in FLASH memory for use in encrypting or decrypting of data in future communications with the other device. It should be noted that a valid UAN must be received by either device in order for the device to acknowledge with a RAK, which is generated by an on board random number generator and associated with the received account number. Additionally, the device that initially receives the UAN logs the appropriate address for the originating device. This address is known as the Originating Device Address (ODA). All subsequent communications to a device must originate at the same ODA address in order to use the MAK that was created between the pair of devices.

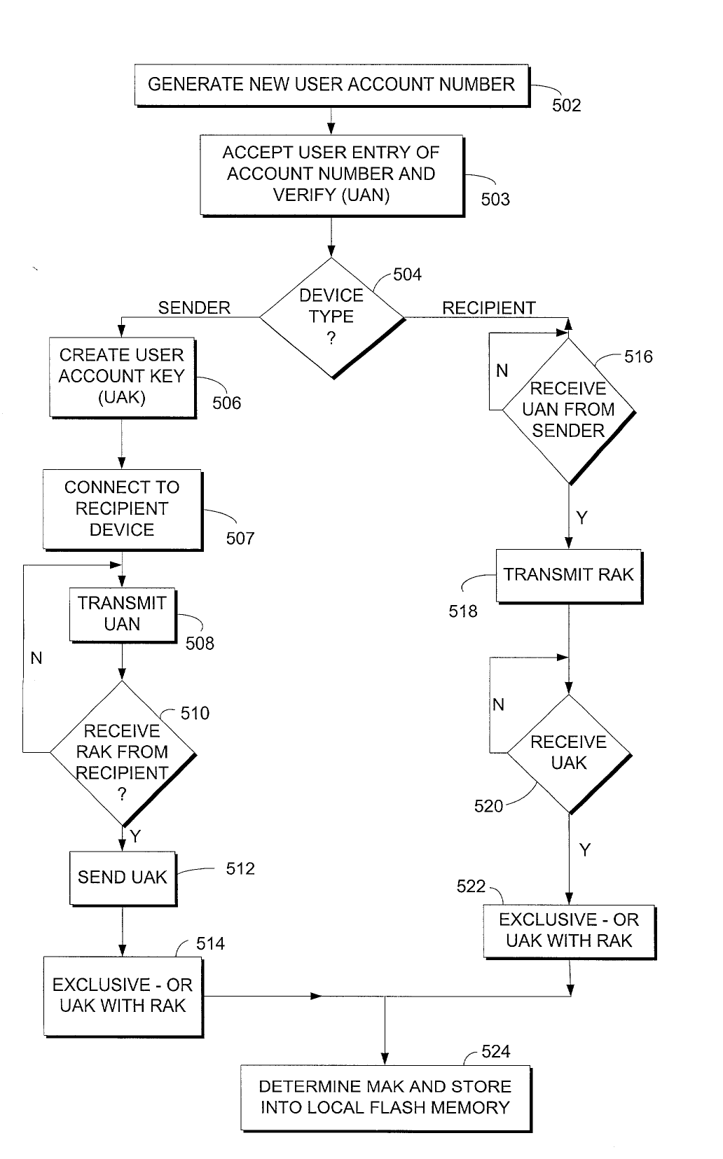

An MAK is formed from certain sub-key components during the steps described above. The sub-key components are also retained in memory by each device. FIG. 6 is an exemplary illustration of the sub-key components associated with an MAK. This method of utilizing sub-key components serves a dual purpose. On the one hand, security is directly linked to both the device and the user entered information. This enables certain key pieces of security information to be exchanged between the devices at any period in time. In other words, there is no requirement that all security related information gets transferred at the time when the user first logs onto the system. On the other hand, the use of sub-key components diminishes the amount of data that is transferred during secure communications. Each message does not need to have a security code or key attached to the transmitted data. This results in an encryption method that does not adversely impact the transmission rate of secured communications.

As would be generally understood, there are additional applications of the present invention that would benefit from the data handling and encryption methods of the present invention. All of these are considered within the scope of the present invention.

We claim:

1. An improved method of encryption for the transmission of information comprising the steps of:
creating an encryption key;
limiting access to an encryption key;
registering an account owner; and
registering a communication device.

2. A method as recited in claim 1 wherein said access to the encryption key is limited to a Transmitting and a Receiving Device.

3. A method as recited in claim 1 wherein said registration of an account comprises:
the registration of a device owner with a Recipient Device; and
the registration of a Transmitting Device with a Recipient Device.

4. A method as recited in claim 3 wherein said registration of an account occurs in an automated manner without user intervention.

5. A method as recited in claim 1, further comprising the step of integrating the encryption key with the communication device hardware.

6. A method as recited in claim 1, further comprising the step of encrypting and decrypting information at speeds that do not impede communication rates.

7. An apparatus for encryption utilizing a combination of hardware and software comprising:
a Transmitting Device;
a Recipient Device;
a message package; and
means for executing algorithm for encryption, decryption and registration.

8. An apparatus as recited in claim 7 wherein said recipient device comprises:
a solid state device pluggable into a standard PC slot;
a non-accessible and non-visible circuit card embedded on said solid state device;
a connector for a network or similar communication medium; and
a circuitry able to detect the disconnection of said solid state device from the PC.

9. A method for secure communication encryption utilizing a combination of hardware and software comprising:
bundling of information into a message package;
sending information via a Transmitting Device;
receiving information via a Recipient Device; and
executing algorithms for encryption, decryption and registration of component devices.

10. A method as recited in claim 9 wherein said message package may precede or be appended to all messages and comprises:
a non-encrypted message Key; and
an identification of the sending device hardware.

11. A method as recited in claim 9 wherein said sending of information comprises:
registering said recipient device;
establishing a master key that is locally stored;
implementing software programs to prevent access to account keys;
executing an encryption algorithm;
allowing real time audio or audio/visual communications; and sending files.

12. A method as recited in claim 9 wherein said receiving of information comprises:
receiving files;
allowing the real-time audio or audio/visual conversations over a digital network;
executing a decryption algorithm;
registering said transmitting device;
establishing a master Key that is locally stored; and
implementing software programs to prevent access to account Keys.

13. A method as recited in claim 12 wherein said receiving of information occurs with respect to communications between a Recipient Device and a plurality of Transmitting Devices.

14. A method as recited in claim 9 wherein the encryption, decryption and registration method comprises the steps of:
formatting a master Key from sub-key components;
incorporating into the Key generation, the date and message number;
retaining the master Key in memory;
matching the information of the device on the opposite end of the communication with the information contained within the Key;
allowing registration at any time of the day or night within a short time frame (a period of less than 30 seconds); and
separating the Key from the data transmission.

15. The method as recited in claim 14 wherein said master Key is formatted from sub-key components that include:
user account Key;
recipient account Key;
Sending Device authentication Key;
Recipient Device authentication Key;
Date and message number; and
certificate of authenticity.

16. A method as recited in claim 14 wherein said formatting of master Key comprises the steps of:
Generating new User Account Numbers (UAN) in the Recipient Device;
accepting a manually entered User Account Number (UAN) in the sending device;
creating a User Account Key (UAK) associated with the user account number (UAN);
connecting the Sending Device with the Recipient Device and transmitting the UAN;
verifying the received UAN and responding with a recipient account Key (RAK);
sending a UAK in response to an RAK; and
performing an exclusive or of RAK and UAK on both ends for the communication to obtain a master authentication Key.
